(19) United States
(12) Patent Application Publication
(10) Pub. No.: US 2023/0399263 A1
(43) Pub. Date: Dec. 14, 2023

(54) ALUMINOUS SINTERED PRODUCT

(71) Applicant: SAINT-GOBAIN CENTRE DE RECHERCHES ET D'ETUDES EUROPEEN, COURBEVOIE (FR)

(72) Inventors: Thibault CHAMPION, VILLELAURE (FR); Michel BOBO, SAINT SATURNIN LES AVIGNON (FR)

(21) Appl. No.: 18/034,879

(22) PCT Filed: Oct. 29, 2021
(86) PCT No.: PCT/EP2021/080193

§ 371 Date: May 1, 2023

(30) Foreign Application Priority Data
Nov. 2, 2020 (FR) 2011202

(51) Int. Cl. C04B 35/111; C04B 28/06; C04B 35/626; C04B 35/64; C03B 5/43; C03B 17/04; C03B 7/02

(52) U.S. Cl. CPC C04B 35/111; C04B 28/06; C04B 35/62655; C04B 35/64; C03B 5/43; C03B 17/04; C03B 7/02; C04B 2235/3222; C04B 2235/3201; C04B 2235/3418; C04B 2235/5436; C04B 2235/612; C04B 2235/9669

(57) ABSTRACT

A sintered product having:
the following chemical analysis, as percentage by mass based on the oxides:
   Al₂O₃: remainder to 100%,
   0.26%≤Na₂O≤4%,
   0%≤oxides other than Al₂O₃ and Na₂O≤6%, provided that SiO₂≤2%,
the following crystalline phases, as percentages by mass based on the total amount of crystalline phases:
   5%≤beta-alumina≤37%,
   less than 6% of crystalline phases other than beta-alumina and alpha-alumina,
   remainder to 100%: alpha-alumina.

### TECHNICAL FIELD

The invention relates to an aluminous sintered product, to a process for manufacturing such a product, to a particulate mixture and a starting feedstock that are suitable for this process, and to a preform leading, via sintering, to said aluminous product.

### PRIOR ART

Among refractory products, a distinction is made between fused cast products and sintered products.

Unlike sintered products, fused cast products, as described for example in US 2001/0019992, most often comprise an intergranular vitreous phase connecting crystalline grains. The problems posed by sintered products and by fused cast products, and the technical solutions adopted to solve them, are therefore generally different. A composition developed for manufacturing a fused cast product is therefore not a priori usable for manufacturing a sintered product having the same properties, and vice versa.

The sintered products are obtained by mixing appropriate starting materials and then shaping this mixture in the form of a preform and firing said preform at a temperature and for a time that are sufficient to achieve the sintering of said preform. This firing can be performed in firing kilns or else in situ, in the glass furnace for products sold unsintered or unshaped.

Depending on their chemical composition and their manner of preparation, sintered products are intended for a wide variety of industries.

Among sintered products, aluminous products are known to be used in installations for the manufacture of glass articles, in particular in the distribution channels or “feeders”.

There is a constant need for an aluminous sintered refractory product having:
low degree of bubbling when it is in contact with molten glass, which makes it possible to reduce the amount of defects in the glass articles manufactured,
low penetration by said molten glass, which makes it possible to increase the duration of use of said product, in particular by avoiding any deterioration in its properties, and
low deformation during the sintering, which makes it possible to obtain dimensionally compliant parts and to limit scrap as well as rework operations by machining.

One aim of the invention is to at least partially address this need.

### SUMMARY OF THE INVENTION

According to the invention, this aim is achieved by means of a particulate mixture consisting of particles the composition and crystallographic structure of which are adapted to form, by heating at 1350° C. for 10 hours, a sintered product having:
the following chemical analysis, as percentage by mass based on the oxides:
   Al₂O₃: remainder to 100%,
   0.26%≤Na₂O≤4%,
   0%≤oxides other than Al₂O₃ and Na₂O≤6%, provided that SiO₂≤2%,
the following crystalline phases, as percentages by mass based on the total amount of crystalline phases:
   5%≤beta-alumina≤37%,
   less than 6% of crystalline phases other than beta-alumina and alpha-alumina,
   remainder to 100%: alpha-alumina.

The particulate mixture may contain a binder in particulate form. Preferably, the binder is chosen from a hydraulic cement, a resin, a lignosulfonate, a cellulose derivative, dextrin, a gelatin, an alginate, a tylose, pectin, anhydrous phosphoric acid, an aluminum monophosphate, alumina hydrates, an anhydrous sodium silicate, an anhydrous potassium silicate, and mixtures thereof.

The particulate mixture may contain a shaping agent in particulate form, preferably selected from a clay, a plasticizer, such as polyethylene glycol (or “PEG”) or polyvinyl alcohol (or “PVA”), a deflocculant, such as an alkali metal polyacrylate, a polycarboxylate, a polysulfonate, a cementitious setting accelerator, a cementitious setting retarder, and a mixture of these agents.

The particulate mixture may contain fibers, preferably organic fibers, preferably of the vinyl or polypropylene type, preferably in an amount by mass of between 0.01% and 0.1%, preferably in an amount by mass of between 0.01% and 0.03%. Preferably, the mean length (arithmetic mean) of these fibers is greater than 6 mm, preferably between 18 and 24 mm. These fibers advantageously facilitate the removal of water during drying.

In a preferred embodiment, the particulate mixture does not contain fibers.

A particulate mixture according to the invention may for example be packaged in drums or in bags.

When the sintered product is a sintered concrete, the particulate mixture according to the invention preferably comprises
between 1% and 8%, preferably between 2% and 6%, of a hydraulic cement, preferably an aluminous cement, preferably a calcium aluminate cement, and
between 0.05% and 1%, preferably between 0.1% and 0.8%, of a deflocculant, preferably a polycarboxylate, and/or between 0% and 0.1% of a cementitious setting accelerator and/or between 0% and 0.1% of a cementitious setting retarder.

A particulate mixture according to the invention advantageously makes it possible to manufacture a sintered product according to the invention, said sintered product having:
the following chemical analysis, as percentage by mass based on the oxides:
   Al₂O₃: remainder to 100%,
   0.26%≤Na₂O≤4%,
   0%≤oxides other than Al₂O₃ and Na₂O≤6%, provided that SiO₂≤2%,
the following crystalline phases, as percentages by mass based on the total amount of crystalline phases:
5%≤beta-alumina≤37%,
less than 6% of crystalline phases other than beta-alumina and alpha-alumina,
remainder to 100%: alpha-alumina.

The inventors have discovered that the sintered product according to the invention exhibits very good behavior in contact with a molten glass, and in particular exhibits good resistance to bubbling and to penetration by the molten glass. In addition, it has good resistance to deformation during sintering.

A particulate mixture according to the invention preferably exhibits one or more of the following optional characteristics:
the particulate mixture comprises more than 15%, preferably more than 20%, and/or less than 35%, preferably less than 30%, as percentage by mass, of particles having a size of less than 10 μm (fraction F1);
the particulate mixture comprises more than 15%, preferably more than 20%, and/or less than 30%, as percentage by mass, of particles having a size of less than 5 μm (fraction F2);
more than 80%, preferably more than 85%, preferably more than 90%, preferably more than 95%, or even 100% of the fraction F1 and/or of the fraction F2, as percentage by mass, consists of alpha-alumina particles;
the particulate mixture comprises less than 20%, preferably less than 15%, and/or preferably more than 5%, as percentage by mass, of particles having a size of greater than 10 μm and less than 40 μm (fraction F3);
more than 80%, preferably more than 90%, of the fraction F3, as percentage by mass, consists of alpha-alumina particles;
the particulate mixture comprises more than 28%, preferably more than 30%, preferably more than 32%, and/or less than 50%, preferably less than 45%, as percentage by mass, of particles having a size of less than 44 μm;
the particulate mixture comprises more than 20%, preferably more than 25%, preferably more than 30%, and/or less than 45%, preferably less than 40%, as percentage by mass, of alpha-alumina particles having a size of less than 44 μm;
the particulate mixture comprises less than 60%, preferably less than 50%, and/or preferably more than 20%, preferably more than 25%, preferably more than 30%, of particles having a size of greater than 500 μm, as percentage by mass;
the particulate mixture comprises less than 20%, preferably less than 15%, preferably less than 10%, preferably less than 8%, preferably less than 5%, of alpha-alumina particles having a size of greater than 500 μm (fraction F4), preferably of alpha-alumina particles having a size of greater than 200 μm (fraction F5), preferably of alpha-alumina particles having a size of greater than 100 μm (fraction F6), as percentage by mass;
the particulate mixture comprises more than 10%, preferably more than 20%, preferably more than 30%, and/or less than 50%, preferably less than 45%, of alumina particles based on beta-alumina and having a size of greater than 500 μm, as percentage by mass (fraction F7);
the fraction of particles of the particulate mixture having a size of less than 50 μm comprises more than 80%, preferably more than 85%, of alpha-alumina, as percentage by mass based on the mass of said fraction of particles;
more than 60%, preferably more than 70%, preferably more than 75%, preferably more than 80%, of the particles have a size of less than 2 mm;
more than 40%, preferably more than 50%, preferably more than 55%, of the particles have a size of less than 0.5 mm;
the particulate mixture comprises less than 25%, preferably less than 20%, preferably less than 15%, preferably less than 10%, preferably less than 5%, of alpha-alumina particles having a size of greater than 2 mm, as percentage by mass based on the particulate mixture;
the particulate mixture comprises more than 5%, preferably more than 10%, preferably more than 15%, and/or less than 35%, preferably less than 30%, preferably less than 25%, preferably less than 20%, of particles based on beta-alumina and having a size of greater than 2 mm, as percentage by mass based on the particulate mixture;
the particulate mixture comprises less than 30%, preferably less than 25%, preferably less than 20%, preferably less than 15%, preferably less than 10%, preferably less than 5%, of alpha-alumina particles having a size of greater than 0.5 mm, as percentage by mass based on the particulate mixture;
the particulate mixture comprises more than 8%, preferably more than 10%, preferably more than 15%, preferably more than 20%, preferably more than 25%, preferably more than 30%, more than 35%, and/or less than 50%, preferably less than 45%, preferably less than 40%, of particles based on beta-alumina and having a size of greater than 0.5 mm, as percentage by mass based on the particulate mixture.

To manufacture a sintered product according to the invention, a starting feedstock comprising a particulate mixture according to the invention is put into the form of a preform.

The invention also relates to the starting feedstock and the preform.

In particular, it relates to a starting feedstock having the following composition, as percentage by mass:
remainder to 100%: particulate mixture according to the invention;
between 1% and 15% of a solvent, preferably water;
between 0% and 10% of a liquid binder;
between 0% and 5% of a liquid shaping agent.

A starting feedstock according to the invention may be packaged in drums.

Preferably, the preform is dry, which facilitates the handling thereof.

The invention also relates to a process for manufacturing a sintered product according to the invention, comprising at least the following successive steps:
a) mixing particulate starting materials to form a particulate mixture according to the invention,
b) producing a starting feedstock according to the invention, comprising said particulate mixture and a solvent,
c) shaping said starting feedstock so as to obtain a preform according to the invention, d) optionally, drying said preform,
e) sintering said preform so as to obtain said sintered product,
   the composition of the starting feedstock, and in particular of the particulate mixture, being adapted such that the sintered product obtained after step e) is in accordance with the invention.

In one embodiment, the starting feedstock is shaped in situ, that is to say at the location at which the product according to the invention, in an operating position, is intended to be brought into contact with molten glass.

In one embodiment, the preform, which is preferably dry, is disposed in the operating position, and then sintered in situ, preferably during the rise in temperature of the furnace.

In one embodiment, the preform is dried, is at least partially machined, is made of a hardened concrete, and is disposed in the operating position, and then sintered in situ, preferably during the rise in temperature of the furnace.

The invention also relates to the preform obtained on conclusion of step c) or d) of the manufacturing process according to the invention.

Preferably, a particulate mixture or a sintered product according to the invention also comprises one, and preferably multiple, of the following optional characteristics:
the amount of beta-alumina, as percentage by mass based on the total amount of crystalline phases, is greater than 24% and less than 35%;
the Na₂O content, as percentage by mass based on the oxides, is greater than 1.6% and less than 2.9%;
the SiO₂ content, as percentage by mass based on the oxides, is less than 1%;
the content of oxides other than Al₂O₃ and Na₂O, as percentage by mass based on the oxides, is less than 2%;
the CaO content, as percentage by mass based on the oxides, is greater than 0.3%;
the amount of amorphous phase present in the sintered product, based on the mass of the sintered product, is less than 3%;
the sintered product is in the form of a sintered concrete;
the sintered product has the shape of a block of more than 1 kg, an open porosity of greater than 10% and less than 25%, and an apparent density of greater than 2.8 g/cm³ and less than 3.2 g/cm³.

The characteristics relating
to the chemical analysis that are described above for a particulate mixture or a sintered product according to the invention are based on the mass of all the oxides,
to the crystalline phases that are described above for a particulate mixture or a sintered product according to the invention are based on the total amount of crystalline phases, and
to the particle size that are described above for a particulate mixture according to the invention are preferably based on the mass of the particulate mixture.

The invention lastly relates to a glass production unit, in particular a glass furnace, comprising a part comprising or, preferably, consisting of a sintered product according to the invention, preferably manufactured according to the process according to the invention, and/or, preferably, a preform obtained on conclusion of step c) or d), respectively, of the process according to the invention.

In particular, and without limiting the invention, said part may be:
a block of a feed channel,
a burner block,
an expendable, for example a lining, a plunger, a stirrer, a rotor, an orifice ring, a feeder spout,
a mandrel used in the manufacture of glass tubes according to the Danner process,
a pool block,
a superstructure part of a feed channel, in particular a covering part.

### Definitions

Unless indicated otherwise, the “oxides” are inorganic oxides.
The oxide contents relate to the overall contents for each of the corresponding chemical elements, expressed in the form of the most stable oxide, according to the standard industry convention.
Unless indicated otherwise, all the oxide contents of the products according to the invention are percentages by mass expressed on the basis of the oxides.
The term “beta-alumina” refers to a compound having the formula 11Al₂O₃·XNa₂O with 1≤X≤1.6, and having a hexagonal crystallographic structure.
A particle or a powder “based” on beta-alumina preferably comprises more than 30%, more than 40%, more than 45%, more than 50%, of beta-alumina, as percentages by mass based on the crystalline phases. In one embodiment, a particle or a powder “based” on beta-alumina comprises less than 70%, or even less than 60%, of beta-alumina, as percentages by mass based on the crystalline phases.
The term “particulate mixture” is understood to mean a dry mixture of particles (not bonded together). The term “particle” is understood to mean a solid object within a particulate mixture.
The term “unshaped concrete” is understood to mean a particulate mixture comprising a hydraulic binder capable of solidifying after activation.
Activation is a process of solidification. The activated state conventionally results from wetting an unshaped concrete with water or another liquid. During this process, a wet unshaped concrete is referred to as “fresh concrete”.
The solid mass obtained by the solidification of a fresh concrete is referred to as “hardened concrete”. A hardened concrete is conventionally constituted of a assembly of coarse grains having a size of between 50 μm and 25 mm bonded by a matrix, said matrix ensuring a substantially continuous structure between the coarse grains, this being obtained, after activation, during the solidification of the starting feedstock.
“Sintering” is a heat treatment of a preform via which is formed a matrix that bonds together coarse grains of said preform. After sintering a hardened concrete, a “sintered concrete” is obtained. The dimensions of the coarse grains of the preform, and in particular of a hardened concrete, are substantially not modified when this preform is sintered. In a sintered concrete, the coarse grains thus have a size of between 50 μm and 25 mm.
The term “hydraulic binder” is understood to mean a binder which, on activation, causes setting and hydraulic hardening, generally at ambient temperature. A cement is a hydraulic binder. It is considered here that an aluminous cement is a cement containing more than 60%, preferably more than 65%, of Al₂O₃, as percentage by mass based on the oxides. A calcium aluminate cement is an example of an aluminous cement.
The “size” of the particles is evaluated conventionally by a characterization of particle size distribution carried out with a laser particle sizer for the fraction of the particles passing through a square-mesh sieve with an opening equal to 150 μm and, for the oversize of said sieve, by sieving using square-mesh sieves. The laser particle sizer may, for example, be a Partica LA-950 from Horiba.
   The 50 (D₅₀) and 99.5 (D_{99.5}) percentiles or “centiles” are the sizes of particles of a powder corresponding to the percentages by mass of 50% and of 99.5%, respectively, on the cumulative particle size distribution curve of the sizes of the particles of the powder, the sizes of the particles being categorized in increasing order. For example, 99.5% by mass of the particles of the powder have a size of less than D_{99.5} and 50% of the particles by mass have a size of greater than or equal to D₅₀. The percentiles may be determined using a particle size distribution produced using a laser particle sizer and/or sieving operations.
   “Median size” refers to the 50 (D₅₀) percentile.
   “Maximum size” refers to the 99.5 (D_{99.5}) percentile.
The expressions “containing a”, “comprising a” or “having a” are understood to mean “comprising at least one”, unless indicated otherwise.

### BRIEF DESCRIPTION OF THE DRAWINGS

Other characteristics and advantages of the invention will emerge further on reading the detailed description that follows and on examining the appended drawing in which FIG. 1

FIG. 1 schematically illustrates a device for measuring the heat distortion.

### DETAILED DESCRIPTION

Manufacturing Process

The process for manufacturing a sintered product according to the invention comprises steps a) to e), which are conventional but which are adapted to the invention.

In step a), a particulate mixture comprising particles of refractory oxides (or “refractory particles”) is prepared.

The particle size of the particulate mixture is adapted, in particular depending on the shaping in step c). Andreasen or Fuller-Bolomey packing models may be used. Such packing models are described in particular in the work entitled “Trait\tilde{e} de céramiques et matériaux minéraux” [Treatise on Ceramics and Inorganic Materials], C. A. Jouenne, published by Septima, Paris (1984), pages 403 to 405.

In a preferred embodiment, the particle size of the particulate mixture is adapted so that the sintered product is a sintered concrete.

Preferably, in particular when the sintered product is a sintered concrete, the particulate mixture according to the invention comprises preferably more than 10%, preferably more than 15%, preferably more than 20%, and less than 50%, preferably less than 40%, or even less than 35%, or even less than 30%, of particles having a size of less than 50 μm, as percentage by mass.

Preferably, in particular when the sintered product is a sintered concrete, at least 90% by mass of the particles with a size of less than 50 μm of the particulate mixture according to the invention have a size of less than 40 μm, preferably less than 30 μm, preferably less than 20 μm, or even less than 10 μm.

Preferably, the fraction of the particles of the particulate mixture having a size of less than 50 μm comprises less than 30%, preferably less than 25%, preferably less than 20%, preferably less than 15%, preferably less than 10%, preferably less than 5%, of particles based on beta-alumina, as percentage by mass based on said fraction.

In one embodiment, in particular when the sintered product is a sintered concrete, the fraction of the particles of the particulate mixture having a size of less than 50 μm preferably comprises alpha-alumina particles, cement particles and shaping agent particles, preferably alpha-alumina particles, cement particles and deflocculant particles.

The particulate mixture preferably comprises less than 90%, preferably less than 85%, preferably less than 80%, of particles with a size of between 50 μm and 25 mm, as percentage by mass.

Preferably, at least 90% by mass of the particles with a size of greater than or equal to 50 μm have a size of greater than 100 μm, preferably greater than 200 μm, preferably greater than 300 μm, preferably greater than 400 μm.

More preferably still, more than 80%, preferably more than 90%, preferably more than 95%, preferably more than 99%, by mass of the particles with a size of greater than or equal to 50 μm have a size of greater than 200 μm, preferably greater than 300 μm, preferably greater than 400 μm, or even greater than 0.5 mm and/or less than 10 mm, preferably less than 5 mm.

More preferably still, the particulate mixture contains at least 10% of particles with a size of greater than 2 mm, as percentage by mass.

In a manner well known to those skilled in the art, the composition of the particulate mixture is adapted to the desired composition for the sintered product to be manufactured. In particular, the oxides present in the particulate mixture are found, substantially in their entirety, in the sintered product. The composition, on the basis of the oxides, is therefore substantially identical in the particulate mixture, in the preform and in the sintered product. The binder and/or the shaping agent, present in a particulate form, which may be present in the particulate mixture according to the invention, are chosen in particular depending on the shaping technique used during step c) of the process according to the invention.

The particulate mixture may have:
the following chemical analysis, as percentage by mass based on the oxides:
   Al₂O₃: remainder to 100%,
   0.26%≤Na₂O≤4%,
   0%≤oxides other than Al₂O₃ and Na₂O≤6%, provided that SiO₂≤2%,
the following crystalline phases, as percentages by mass based on the total amount of crystalline phases:
   5%≤beta-alumina≤37%,
   less than 6% of crystalline phases other than beta-alumina and alpha-alumina,
   remainder to 100%: alpha-alumina.

It may also have one or more of the optional characteristics relating to the composition of the sintered product according to the invention, described below.

In a preferred embodiment, Al₂O₃ is provided, preferably exclusively, by one or more powders of alpha-alumina, of beta-alumina and optionally by the hydraulic cement. During the manufacture of the sintered product, the crystallographic phases of alpha-alumina and beta-alumina are substantially retained.

The starting material powders are preferably intimately mixed to obtain the particulate mixture according to the invention.

In step b), a starting feedstock is prepared, preferably at ambient temperature, from the particulate mixture. It comprises the particulate mixture according to the invention, a solvent, preferably water, and optionally a liquid binder, in particular when the particulate mixture according to the invention does not comprise a binder in a particulate form, and/or one or more liquid shaping agents.

As examples of liquid binders that can be used, mention may be made, in nonlimiting fashion, of phosphoric acid in solution, ethyl silicate, and colloidal silica.

In one embodiment, the particulate mixture according to the invention does not comprise cement. In a preferred embodiment, the particulate mixture according to the invention comprises a cement and the starting feedstock does not comprise a liquid binder.

The particulate mixture preferably comprises more than 1%, preferably more than 2%, and/or less than 8%, preferably less than 6%, as percentage based on the mass of the particulate mixture.

In one embodiment, the starting feedstock does not comprise a liquid binder.

The solvent is preferably water.

As is well known to those skilled in the art, the amount of solvent, preferably water, depends in particular on the shaping technique in step c).

If a technique of shaping by casting or vibrocasting is used in step c), the amount of solvent, preferably water, is greater than 4%, preferably greater than 5%, and/or less than 7%, preferably less than 6%, as percentage by mass relative to the mass of the particulate mixture. If a technique of shaping by uniaxial pressing is used in step c), the amount of solvent, preferably water, is greater than 2%, preferably greater than 3%, and/or less than 6%, preferably less than 5%, as percentage by mass relative to the mass of the particulate mixture. When the particulate mixture comprises a hydraulic cement, the addition of water activates the hydraulic cement, that is to say causes it to start solidifying.

When the particulate mixture comprises a hydraulic cement, the amount of solvent, preferably water, is preferably greater than 3%, preferably greater than 4%, preferably greater than 5%, and preferably less than 9%, preferably less than 8%, preferably less than 7%, as percentage by mass relative to the mass of the particulate mixture.

The starting feedstock is conventionally mixed in a mixer.

In step c), the starting feedstock is shaped.

All of the conventional methods used to manufacture preforms, in particular made of a hardened concrete, may be envisaged.

The shaping may comprise an isostatic pressing, slip casting, uniaxial pressing, casting of a gel, vibrocasting or a combination of these techniques.

Preferably, the starting feedstock is poured into a mold.

Preferably, when the sintered product according to the invention is a sintered concrete, the starting feedstock is poured into a mold where it hardens, in particular via the solidification resulting from the reaction of the hydraulic cement with the solvent, preferably the water.

Preferably, the mold is shaped such that the sintered product has the shape of a block, all the dimensions of which are greater than 1 mm, greater than 5 mm, greater than 5 cm, and all the dimensions of which are preferably less than 500 cm.

Preferably, the mold is shaped such that the sintered product has a mass of greater than 1 kg, greater than 5 kg, greater than 10 kg, or even greater than 100 kg, and/or less than 2500 kg, or even less than 2000 kg.

After demolding, a block called a “preform” is obtained.

During shaping, in particular during solidification when the sintered product is a sintered concrete, the amounts of oxides, and in particular of alpha-alumina and beta-alumina, and their crystallographic structure are substantially not modified.

The preform, according to the invention, may thus have:
the following chemical analysis, as percentage by mass based on the oxides:
   Al₂O₃: remainder to 100%,
   0.26%≤Na₂O≤4%,
   0%≤oxides other than Al₂O₃ and Na₂O≤6%, provided that SiO₂≤2%,
the following crystalline phases, as percentages by mass based on the total amount of crystalline phases:
   5%≤beta-alumina≤37%,
   less than 6% of crystalline phases other than beta-alumina and alpha-alumina,
   remainder to 100%: alpha-alumina.

It may also have one or more of the optional characteristics relating to the composition of the sintered product according to the invention.

In step d), the preform may undergo a drying step, in order to remove a portion of the water that has been used for the shaping. Preferably, the drying results in a preform having a residual moisture content of less than 2%. Such a step is fully known to those skilled in the art. All drying techniques can be envisaged.

In step e), the preform is sintered so as to obtain a sintered product according to the invention.

The sintering is preferably performed at atmospheric pressure, preferably with a stationary temperature phase of a duration greater than 5 hours and/or less than 15 hours, at a temperature of greater than 1100° C. and/or less than 1700° C.

Sintering may be carried out in situ, i.e. after the hardened block has been positioned in its operating position, in the glass manufacturing installation.

In this embodiment, the mold can even be disposed such that after demoulding the hardened block is in its operating position. It is then shaped in situ and at least partly sintered in situ. Shaping in situ makes it possible to manufacture large blocks, which are impossible or difficult to move later.

Sintering results in a sintered product according to the invention.

The sintered product preferably comprises more than 98%, preferably more than 99%, preferably substantially 100%, of oxides, based on the mass of the sintered product.

Preferably, the shaping and the sintering are adapted, in known manner, such that:
the open porosity of the sintered product is greater than 8%, preferably greater than 10%, preferably greater than 12%, preferably greater than 14%, or even greater than 15%, or even greater than 17%, and/or less than 25%, preferably less than 20%, preferably less than 18.5%; and/or
the apparent density of the sintered product is greater than 2.8 g/cm 3, preferably greater than 2.9 g/cm 3, and/or less than 3.2 g/cm 3, preferably less than 3.1 g/cm 3.

Preferably, in the sintered product:—
the Al₂O₃ content, as percentage by mass based on the oxides, is greater than 94%, preferably greater than 95%, preferably greater than 95.5%, and/or less than 98.5%, preferably less than 98%, preferably less than 97.5%; and/or
the Na₂O content, as percentage by mass based on the oxides, is greater than 0.35%, preferably greater than 0.5%, preferably greater than 0.78%, preferably greater than 1%, preferably greater than 1.4%, preferably greater than 1.6%, preferably greater than 1.8%, preferably greater than 2%, and/or less than 2.9%, preferably less than 2.6%; and/or
more than 85%, preferably more than 90%, preferably more than 93%, preferably more than 95% of the Na₂O is in the form of beta-alumina; and/or
the content of oxides other than Al₂O₃ and Na₂O, as percentage by mass based on the oxides, is less than 5%, preferably less than 4%, preferably less than 3%, preferably less than 2%, preferably less than 1.8%, and/or greater than 0.1%; and/or
the SiO₂ content, as percentage by mass based on the oxides, is less than 1.5%, preferably less than 1%, preferably less than 0.8%, preferably less than 0.7%, preferably less than or equal to 0.6%; and/or
in particular when the sintered product is a sintered concrete, the CaO content, as percentage by mass based on the oxides, is greater than 0.3%, preferably greater than 0.5%, preferably greater than 0.6%, and/or less than 2%, preferably less than 1.8%, preferably less than 1.5%, preferably less than 1.3%, preferably less than 1%; and/or
the amount of beta-alumina, as percentage by mass based on the total amount of crystalline phases, is greater than 7%, preferably greater than 10%, preferably greater than 15%, preferably greater than 20%, preferably greater than 24%, preferably greater than 27%, and/or less than 35%, preferably less than 32%; and/or
the amount of crystalline phases other than beta-alumina and alpha-alumina, as percentage by mass based on the mass of the crystalline phases, is less than 5%, preferably less than 4%, preferably less than 3%; and/or
the amount of amorphous phase present in the sintered product, based on the mass of the sintered product, is less than 5%, preferably less than 4%, preferably less than 3%.

### EXAMPLES

The following nonlimiting examples are given for the purpose of illustrating the invention.

In these examples, the following starting materials used are chosen, the percentages given being percentages by mass:
T60 tabular alpha-alumina powders sold by Almatis,
powders based on beta-alumina having the following chemical analysis, as percentages by mass: Al₂O₃: 95%, Na₂O: 4%, other compounds: 1%, and the following crystallographic analysis, as percentages by mass based on the crystalline phases: beta-alumina: 53%, alpha-alumina: 45%, the amount of amorphous phase being equal to 2%, as percentage by mass based on the powder under consideration,
a powder of fine particles based on beta-alumina, having the following chemical analysis, as percentages by mass: Al₂O₃: 95%, Na₂O: 4%, other compounds: 1%, and the following crystallographic analysis, as percentages by mass based on the crystalline phases: beta-alumina: 53%, alpha-alumina: 45%, the amount of amorphous phase being equal to 2%, as percentage by mass based on the powder, and a median size (D₅₀) equal to 23 μm,
a calcined alpha-alumina powder, having a content by mass of Al₂O₃ of greater than 99.7% and a median size (D₅₀) equal to 4.8 μm,
a reactive alpha-alumina powder, having a content by mass of Al₂O₃ of greater than 99.7% and a median size (D₅₀) equal to 1.5 μm,
a fine alpha-alumina powder, having a content by mass of Al₂O₃ of greater than 95%, a median size (D₅₀) equal to 40 μm and a size D₉₀ equal to 100 μm,
CA270 cement sold by Almatis, having a median size (D₅₀) equal to 6 μm,
a modified polycarboxylate ether.

Parts are manufactured according to a process in accordance with the invention.

In step a), the oxide powders and the modified polycarboxylate ether are metered out and mixed so as to form a particulate mixture.

In step b), the particulate mixture and water are introduced into a mixer. After mixing for a duration of 20 minutes, a starting feedstock is obtained.

In step c), the starting feedstock is cast into a wooden mold, so as to obtain a preform in the form of a brick having a length equal to 230 mm, a width equal to 115 mm and a thickness equal to 115 mm, and a preform in the form of a bar having a length equal to 500 mm and a cross section equal to 40 mm×40 mm.

The bar is used, after drying, for characterizing the deformation during sintering.

In step d), after demolding and drying at 110° C. for 24 hours, the preform in the form of a brick is sintered in the following thermal cycle:
rise from ambient temperature up to 1350° C. at a rate of 30° C./h,
maintenance at 1350° C. for 10 hours,
fall in temperature at a rate equal to 30° C./h down to 500° C., then a free fall down to ambient temperature (20° C.).

Table 1 below summarizes, for each example, the composition of the particulate mixture in step a) and of the starting feedstock in step b).

TABLE 1

| | | Example | | | | |
|---|---|---|---|---|---|---|
| | | 1 | 2 | 3 | 4 | 5 |
| Particulate | 1 to 3 mm tabular alumina powder (%) | 12 | 13 | 8 | 0 | 0 |
| mixture | 1 to 2 mm tabular alumina powder (%) | 15 | 7 | 4 | 0 | 0 |
| | 0.5 to 1 mm tabular alumina powder (%) | 11 | 7 | 4 | 0 | 0 |
| | 0 to 0.5 mm tabular alumina powder (%) | 18 | 13 | 8 | 0 | 0 |
| | 2 to 5 mm powder based on beta-alumina (%) | 0 | 5 | 10 | 18 | 18 |
| | 0.5 to 2 mm powder based on beta-alumina (%) | 0 | 6 | 12 | 20 | 20 |
| | 0 to 0.5 mm powder based on beta-alumina (%) | 0 | 5 | 10 | 18 | 18 |
| | Fine alpha-alumina powder − D₅₀ = 40 μm (%) | 11 | 11 | 11 | 11 | 0 |
| | Powder of fine particles based on beta- | 0 | 0 | 0 | 0 | 24 |
| | alumina − D₅₀ = 23 μm (%) | | | | | |
| | Calcined alumina powder − D₅₀ = 4.8 μm (%) | 12 | 12 | 12 | 12 | 0 |
| | Reactive alumina powder − D₅₀ = 1.5 μm (%) | 18 | 18 | 18 | 18 | 17 |
| | CA270 cement (%) | 3 | 3 | 3 | 3 | 3 |
| | Total of the oxide powders (%) | 100 | 100 | 100 | 100 | 100 |
| | Modified polycarboxylate ether (% based on | 0.55 | 0.55 | 0.55 | 0.55 | 0.55 |
| | the total mass of the oxide powders) | | | | | |
| Starting | Addition of water to the particulate mixture (% | 4.9 | 5.8 | 5.8 | 5.8 | 5.8 |
| feedstock | based on the particulate mixture) | | | | | |

The chemical analyses are carried out by X-ray fluorescence.

Crystallographic analyses are performed on samples reduced to powder, on a Bruker D5000 appliance sold by Bruker, using a Rietveld refinement.

The bubbling behavior on contact with molten glass of the sintered products of the examples is evaluated by the following method.

Crucibles having
an outer diameter equal to 50 mm,
a total height equal to 50 mm,
a hole concentric with the outer diameter and having a diameter equal to 30 mm, and
a base with a thickness equal to 20 mm
   are machined into the bricks of sintered products of the examples to be tested.

Each crucible is filled with 30 grams of a soda-lime glass powder, the median size of which is equal to 1 mm, the maximum size of which is equal to 5 mm, and having the following chemical analysis by mass: SiO₂: 71.6%, CaO: 12.5%, Al₂O₃: 2%, Na₂O+K₂O: 12.3%, other oxides: 1.6%.

The entirety of the crucible and glass is then placed in an electric furnace and undergoes the following heat treatment, under air:
rise to 1250° C. at a rate equal to 500° C./h,
maintenance at 1250° C. for 30 hours,
fall to 800° C. at a rate equal to 500° C./h,
fall to 660° C. at a rate equal to 20° C./h,
maintenance at 660° C. for 5 hours,
fall to ambient temperature at a rate equal to 8° C./h.

The ratio of the area of the bubbles generated during the test to the area of glass observed can be evaluated with the following nonlimiting method.

After cooling, resin is cast into the crucible so as to completely fill the crucible. The crucible is then cut so as to obtain a slice with a thickness equal to 7 mm, said slice containing the vertical axis of symmetry of the crucible and having a height equal to that of the crucible.

The slice is then polished in order to make the glass transparent and facilitate observations, said polishing being performed at the least with a 1200 grade paper, preferably with a diamond paste.

Images are then acquired with the aid of an optical microscope, a light source illuminating the glass slice from the side opposite the optical microscope (backlighting). This backlighting reveals the bubbles contained in the glass. The focusing, in particular the aperture, is performed such that all the bubbles contained in the part of the glass slice observed appear sharp.

The magnification used is the highest possible magnification making it possible to obtain an image corresponding to 0.5 mm 2 of the surface of the glass of the slice, the total number of images being equal to the number of images necessary to be able to observe the entire surface of the glass of the slice, without overlap.

For each slice, each image t is then analyzed using the imageJ software, available on the site http://rsbweb.nih.gov/ij/according to the following method:
open the image in imageJ;
delete any previous results with the “Analyse>Clear Results” function;
define the magnitude to be measured, in other words the area, by checking only the “Area” box in “Analyze>Set measurements”, and then confirming with “OK”;
adjust the brightness with the “Image>Adjust>Brightness/contrast” function, and then click on “Auto”;
apply a “Gaussian blur” with a sigma (or radius) of a value equal to 2.00 using the “Process>Filters>Gaussian blur” function, and then confirm with the “OK” button;
convert the number of color/gray levels to 8 bits with the “Image>Type>8-bit” function;
binarize the image using the “Image>Adjust>Threshold>Auto” function, the “Dark Background” box being checked, the drop-down menu corresponding to the type of thresholding being on “Default”, the red thresholding color being selected using the drop-down menu on “Red” (do not check “Stack histogram”, press “Apply” and then close the window);
using the “Freehand” tool selected using the dedicated icon, define, using the mouse, the zone of glass to be analyzed, this zone not containing the bubbles in contact with the inner surfaces of the crucible;
measure the area of said zone, Z_{At}, with the “Analyse>Measure” tool. The area value is displayed in the “Area” column of a window that opens; note the value and close the window;
clear the part of the image located outside the zone of glass to be analyzed with the “Edit>Clear outside” tool, then deselect the previously selected zone of glass to be analyzed with the “Edit>Selection>Select None” tool and clear the results with the “Analyse>Clear results” tool;
select, within the zone of glass to be analyzed, the zones not to be taken into account, such as for example the cracks which can appear during the cooling of the glass. These selections are made using the “Freehand” tool and its dedicated icon;
determine the area Zᵢₜ of each of the zones i not to be taken into account for the image t, successively, using the following sequence of commands: “Analyse>Measure”, then “Analyse>Clear results”, then “Edit>Clear”, then “Edit>Selection>Select None”. Repeat this sequence i times. Z_{BT} refers to the sum of the areas Zᵢₜ;
invert the black and white zones of the image with the “Process>Binary>Make Binary” tool. The bubbles then appear black on a white background (value 255 for white, 0 for black);
some bubbles may appear in the form of unfilled circles (white circles with a black central part). For these bubbles, transform the black color of the central part into white using the “Process>Binary>Fill holes” function;
determine the area of the bubbles using the following commands: “Analyze>Analyze Particles . . . ”, indicating in the “Size” zone: “0-infinity”, in the “Circularity” zone: “0.00-1.00”, in the “Show” zone: “Nothing”, and then check only the boxes: “Display results”, “Clear results”, “In situ Show” and click on “OK”;
save the results file “Results.xls” with the command “File>Save As . . . ”;
open the results file “Results.xls” and form the sum Z_{Ct} of numbers in the “Area” column representing the area of each bubble in the analyzed zone;
calculate the area of glass observed taken into account, equal to the area of glass observed Z_{At} minus the area Z_{Bt} of the excluded zones, Z_{At}-Z_{Bt};
calculate the total area of the bubbles Zc, equal to the sum of the areas Z_{Ct} determined for each image t;
calculate the total area of glass taken into account Z_{A}-Z_{B}, equal to the sum of the observed areas (Z_{At}−Z_{Bt}) determined for each image t;
calculate the ratio of the area of the bubbles Z_{C}, and of the area of glass taken into account Z_{A}-Z_{B}, Z_{C}/(Z_{A}−Z_{B}).

This ratio characterizes the bubbling behavior of the sintered product on contact with the molten glass.

The ability of the molten glass to penetrate into the sintered product is assessed by measuring, after bubbling test and creation of the slice required for the quantification of the bubbling, the mean penetration by the molten glass into the thickness of the walls of the crucible that are in the slice.

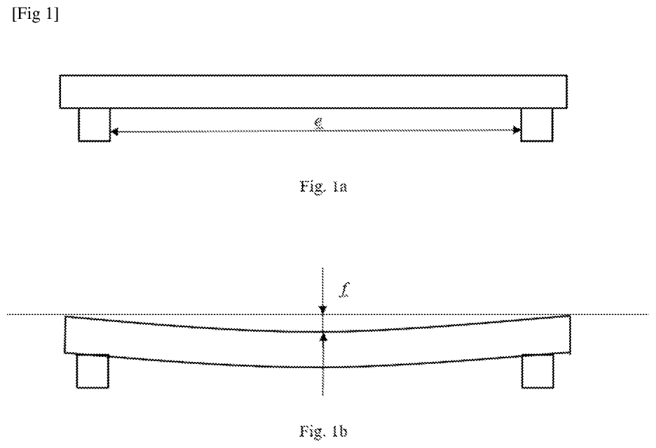

The deformation during the sintering of the products of the examples was evaluated by the following method. A bar of length equal to 500 mm and cross section equal to 40 mm×40 mm of each example of dry product is disposed in an electric furnace, on two sintered alumina supports of dimensions equal to 40×40×40 mm 3, disposed as shown in FIG. 1a, the inside distance between said two supports, e, being equal to 400 mm.

The bars undergo the following heat treatment, in air:
rise to 1350° C. at a rate equal to 30° C./h,
maintenance at 1350° C. for 10 hours,
fall to ambient temperature at a rate equal to 30° C./h.

The deformation during the sintering is the value of the deflection f measured in mm on each bar, as shown in FIG. 1b.

Table 2 below summarizes the characteristics obtained after sintering.

TABLE 2

| | | | | | |
|---|---|---|---|---|---|
| Example | 1* | 2 | 3 | 4 | 5* |

Chemical analysis, as percentages by mass based on the oxides

| | | | | | |
|---|---|---|---|---|---|
| Al₂O₃ | 96.5 | 98.0 | 97.1 | 95.8 | 94.6 |
| Na₂O | 0.2 | 1.0 | 1.6 | 2.5 | 3.4 |
| Other oxides | 3.3 | 1.1 | 1.3 | 1.7 | 2 |
| of which SiO₂ | 2.6 | 0.2 | 0.3 | 0.6 | 0.8 |
| of which CaO | 0 | 0.8 | 0.9 | 0.9 | 0.9 |

Crystallographic analysis, as percentage by mass based on the mass of the crystalline phases

| | | | | | |
|---|---|---|---|---|---|
| Beta-alumina | 0 | 8 | 17 | 30 | 42 |
| Alpha-alumina | >95 | 90 | 81 | 68 | 56 |
| Other crystalline phases | <5 | 2 | 2 | 2 | 2 |

Other characteristics

| | | | | | |
|---|---|---|---|---|---|
| Apparent density (g/cm³) | 2.97 | 3.05 | 2.94 | 2.99 | 2.93 |
| Open porosity (%) | 17.5 | 16.1 | 17.3 | 18.1 | 16.6 |
| Bubble area/area of glass observed | n.d. | 1.9 | 1.2 | 0.8 | <0.1 |
| taken into account (%) | | | | | |
| Mean penetration of the glass into the | 20 | 15 | 10 | 3.3 | 2.8 |
| base of the crucible (mm) | | | | | |
| Deflection f (in mm) | n.d. | 6 | 5.2 | 7.5 | 12 |

n.d.: not determined
*outside of the invention

A measured glass penetration equal to 20 mm means that the glass has passed through the thickness of the base of the crucible.

The ratio of the area of bubbles to the area of glass observed, expressed as percentage, is low for the products of examples 2 to 5.

The ratio of the area of bubbles to the area of glass observed, expressed as percentage, could not be determined for the product of example 1 because there was not enough glass remaining in the crucible after the test.

The mean penetration of the glass into the base of the crucible is lower for the products of example 2 (8% of beta-alumina, mean penetration of the glass into the base of the crucible of 15 mm), of example 3 (17% of beta-alumina, mean penetration of the glass into the base of the crucible of 10 mm), of example 4 (30% of beta-alumina, mean penetration of the glass into the base of the crucible of 3.3 mm) according to invention, and 5 outside of the invention (42% of beta-alumina, mean penetration of the glass into the base of the crucible of 2.8 mm), than that of the product of example 1 outside of the invention (0% of beta-alumina, mean penetration of the glass into the base of the crucible of 20 mm).

Lastly, the deformation during the sintering, measured by the deflection f is lower for the product of examples 2 (8% of beta-alumina, deflection f equal to 6 mm), 3 (17% of beta-alumina, deflection f equal to 5.2 mm) and 4 (30% of beta-alumina, deflection f equal to 7.5 mm) according to the invention, than that of the product of example 5 outside of the invention (42% of beta-alumina, deflection f equal to 12 mm).

The products of examples 2, 3 and 4 according to the invention are therefore the only ones to exhibit a low degree of bubbling on contact with soda-lime glass, low mean glass penetration, and low deformation during the sintering.

The product of example 4 is the product that is preferred among them all.

Of course, the present invention is not limited to the embodiments described, which are provided by way of illustrative and nonlimiting examples.

In particular, the products according to the invention are not limited to particular shapes or dimensions.

1. A sintered product having:
the following chemical analysis, as percentage by mass based on the oxides:
Al₂O₃: remainder to 100%,
0.26%≤Na₂O≤4%,
0%≤oxides other than Al₂O₃ and Na₂O≤6%, provided that SiO₂≤2%, —the following crystalline phases, as percentages by mass based on the total amount of crystalline phases:
5%≤beta-alumina≤37%,
less than 6% of crystalline phases other than beta-alumina and alpha-alumina, remainder to 100%: alpha-alumina,
an open porosity of greater than 10%.

2. The sintered product as claimed in claim 1, wherein the amount of beta-alumina, as percentage by mass based on the total amount of crystalline phases, is greater than 15% and less than 35%.

3. The sintered product as claimed in claim 2, wherein the amount of beta-alumina, as percentage by mass based on the total amount of crystalline phases, is greater than 24% and less than 32%.

4. The sintered product as claimed in claim 1, wherein the Na₂O content, as percentage by mass based on the oxides, is greater than 1.4% and less than 2.9%.

5. The sintered product as claimed in claim 1, wherein the SiO₂ content, as percentage by mass based on the oxides, is less than 1%.

6. The sintered product as claimed in claim 1, wherein the content of oxides other than Al₂O₃ and Na₂O, as percentage by mass based on the oxides, is less than 2%.

7. The sintered product as claimed in claim 1, wherein the CaO content, as percentage by mass based on the oxides, is greater than 0.3%.

8. The sintered product as claimed in claim 1, wherein the amount of amorphous phase present in the sintered product, based on the mass of the sintered product, is less than 3%.

9. The sintered product as claimed in claim 1, in the form of a sintered concrete.

10. The sintered product as claimed in claim 1, having the shape of a block of more than 1 kg, an open porosity of less than 25%, and an apparent density of greater than 2.8 g/cm 3 and less than 3.2 g/cm³.

11. The sintered product as claimed in claim 1, having an open porosity of greater than 12%.

12. The sintered product as claimed in claim 1, wherein the Na₂O content, as percentage by mass based on the oxides, is less than 2.6%.

13. The sintered product as claimed in claim 1, wherein the Na₂O content, as percentage by mass based on the oxides, is greater than 1.6%.

14. A manufacturing process for a sintered product as claimed in claim 1, comprising at least the following successive steps:
a) mixing particulate starting materials to form a particulate mixture,
b) producing a starting feedstock comprising said particulate mixture and a solvent,
c) shaping said starting feedstock so as to obtain a preform,
d) optionally, drying said preform,
e) sintering said preform so as to obtain said sintered product,
the composition of the starting feedstock being adapted such that the sintered product obtained after step e) is in accordance with any one of the preceding claims.

15. The manufacturing process as claimed in claim 14, wherein the preform is disposed in the operating position, and then sintered in situ, preferably during the rise in temperature of the furnace.

16. The manufacturing process as claimed in claim 14, wherein, in said particulate mixture, the fraction of particles having a size of less than 50 μm comprises less than 30% of particles based on beta-alumina, as percentage by mass based on said fraction.

17. The manufacturing process as claimed in claim 16, wherein said fraction of particles having a size of less than 50 μm comprises less than 20% of particles based on beta-alumina, as percentage by mass based on said fraction.

18. The manufacturing process as claimed in claim 17, wherein said fraction of particles having a size of less than 50 μm comprises less than 10% of particles based on beta-alumina, as percentage by mass based on said fraction.

19. The manufacturing process as claimed in claim 14, wherein the particulate mixture comprises more than 20% of particles having a size of less than 50 μm, as percentage by mass, the sintered product preferably being a sintered concrete.

20. The manufacturing process as claimed in claim 14, wherein the particulate mixture comprises more than 28%, as percentage by mass, of particles having a size of less than 44 μm.

21. The manufacturing process as claimed in claim 20, wherein the particulate mixture comprises more than 30% and less than 50%, as percentage by mass, of particles having a size of less than 44 μm.

22. The manufacturing process as claimed in claim 14, wherein the particulate mixture comprises more than 20%, as percentage by mass, of alpha-alumina particles having a size of less than 44 μm.

23. The manufacturing process as claimed in claim 22, wherein the particulate mixture comprises more than 25% and less than 45%, as percentage by mass, of alpha-alumina particles having a size of less than 44 μm.

24. The manufacturing process as claimed in claim 22, wherein the particulate mixture comprises more than 30%, as percentage by mass, of alpha-alumina particles having a size of less than 44 μm.

25. The manufacturing process as claimed in claim 14, wherein the particulate mixture comprises less than 25% of alpha-alumina particles having a size of greater than 2 mm, as percentage by mass based on the particulate mixture.

26. A preform obtained on conclusion of step c) or d) of the manufacturing process as claimed in claim 14.

27. The preform as claimed in claim 26, said preform being dried, being at least partly machined and being made of a hardened concrete.

28. A glass production unit comprising a part comprising a sintered product as claimed in claim 1.

29. The glass production unit as claimed in claim 28, wherein said part is chosen from the group consisting of:
a channel block of a feed channel,
a burner block,
a lining, a plunger, a stirrer, a rotor, an orifice ring, a feeder spout,
a mandrel used in the manufacture of glass tubes according to the Danner process,
a pool block,
a superstructure part of a feed channel.

30. A glass production unit comprising a part comprising a sintered product manufactured by sintering a preform as claimed in claim 26.

31. The glass production unit as claimed in claim 30, wherein said part is chosen from the group consisting of:
a channel block of a feed channel,
a burner block,
a lining, a plunger, a stirrer, a rotor, an orifice ring, a feeder spout,
a mandrel used in the manufacture of glass tubes according to the Danner process,
a pool block,
a superstructure part of a feed channel.
